(19) United States
(12) Patent Application Publication
(10) Pub. No.: US 2005/0229991 A1
(43) Pub. Date: Oct. 20, 2005

(54) Flexible tubular pipe comprising an elastomeric thermoplastic polymer sheath

(76) Inventors: Jean Hardy, Barentin (FR); Alain Coutarel, Mont-Saint-Aignan (FR)

Correspondence Address: OSTROLENK FABER GERB & SOFFEN, 1180 AVENUE OF THE AMERICAS, NEW YORK, NY, 100368403, US

(21) Appl. No.: 10/509,274

(22) PCT Filed: Mar. 21, 2003
(86) PCT No.: PCT/FR03/00909

§ 371 Date: Jun. 9, 2005

(30) Foreign Application Priority Data
Mar. 28, 2002 (FR) 02/03931

(51) Int. Cl. F16L 11/00

(52) U.S. Cl. 138/127; 138/133; 138/138; 428/36.91

(57) ABSTRACT

A flexible tubular pipe for the transfer of fluid in a field of offshore petroleum development. The includes from inside outward an impervious inner polymer sheath, one or more successive reinforcing layers comprising coils of reinforcing wires or metallic strips, or long composite elements and at least one second polymer sheath, comprising at least one of outer protective sheath or an intermediate sheath. The second polymer sheath comprises an elastomeric thermoplastic polymer (TPE).

The present invention relates to a flexible tubular pipe of the type used for the development and transportation of fluids in the offshore petroleum industry. The invention relates more specifically to certain polymer sheaths that are one of the constituent elements of these flexible pipes.

Such pipes are described in many of the Applicant's patents, for instance patents FR 2 782 141 or FR 2 744 511. They satisfy, inter alia, the American Petroleum Institute Recommended Practice 17B (API 17B). These pipes are formed from an assembly of different layers, each intended to allow the flexible pipe to support the operating or handling constraints, and also specific constraints associated with their offshore use. These layers especially comprise polymer sheaths and reinforcing layers formed from coils of reinforcing wires, of strips or of composite material wires, but it may also comprise coils of various bands between the different reinforcing layers. They more particularly comprise at least one impervious inner sheath or pressure sheath for conveying the transported fluid. Said impervious sheath may be the innermost element of the pipe (the pipe is then said to be of “smooth bore” type) or may be arranged around a carcass formed, for example, from a short-pitch coil of a folded-seam strip (the pipe is then said to be of the “rough bore” type). Reinforcing layers formed from a coil of metallic or composite wires are generally arranged around the pressure sheath and may comprise, for example:
pressure armoring formed from a short-pitch coil of a folded-seam metallic reinforcing wire, said pressure armoring being arranged directly around the impervious sheath so as to take up the radial component of the internal pressure;
a binding band formed from a short-pitch coil of a non-folded-seam reinforcing wire lying above the pressure armoring to contribute toward the internal pressure resistance, said binding band and the pressure armoring forming what is known as a pressure vault;
laps of tensile armoring formed from long-pitch coils of metallic or composite reinforcing wires, said laps being intended to take up the axial component of the internal pressure and also the longitudinal stresses to which the pipe is subjected, for instance the laying forces.

An outer polymer sheath or protective sheath is generally provided over the reinforcing layers mentioned previously. In certain cases, an intermediate polymer sheath is also provided. This intermediate sheath may be, for example, an “anti-collapse” sheath laid around the pressure vault. The purpose of this anti-collapse sheath is especially to prevent the collapse of the impervious sheath and of the optional carcass that it surrounds when the annular space (the space between the impervious sheath and the outer sheath) is subjected to an excessive pressure, for instance when the outer sheath is damaged and is no longer impervious.

On account of the specific application of these pipes to the transportation of fluid and especially of hydrocarbons in a marine environment, the set of layers constituting these pipes and in particular the polymer sheaths are subjected to excessively severe conditions that they must be capable of withstanding. Thus, for the polymer sheaths, several problems are encountered depending on the position of the sheath within the pipe (impervious inner sheath, anti-collapse sheath, outer protective sheath).
The impervious sheaths or pressure sheaths are subjected to high temperatures and are in contact with the transported fluid. They must withstand potential chemical attacks by the fluid combined with pressure and temperature constraints.
The outer and intermediate sheaths may also be subjected to temperatures that remain relatively high (up to 100° C.) due to the internal heat conduction. The outer sheaths may also experience very low temperatures due to their use in cold seas, on the one hand, but also, for dynamic “Riser” lines, to local geographical atmospheric conditions (down to −25° C.) and also to attacks by seaspray and by UV for the emerging portion located between the sea surface and the connection under or over the floating support (splash zone). The pipes may also be confronted with problems of tearing or abrasion associated especially with their handling when the pipes are laid, for example. Moreover, their direct contact with the marine environment also raises, for certain polymers used, such as polyamides, polyesters or copolyamides, problems of resistance to hydrolysis. Since the service life of offshore tubular pipes is calculated for a field life of up to 20 years, for example, it is necessary to ensure that the outer sheaths are capable of withstanding the abovementioned stresses throughout this period. The combination of all these constraints is such that the choice of material forming the outer sheath has tended toward materials having a sufficient resistance with regard to the abovementioned constraints.
The intermediate sheaths (or anti-collapse sheaths) are also subjected to severe conditions (pressure, temperature, friction, hydrolysis, etc.) that also make it necessary to ensure their strength over the calculated service life of the pipe.

At the present time, most of the outer and intermediate sheaths are made of thermoplastic such as polyethylene or polyamides. These materials have mechanical characteristics and chemical properties that allow them to obtain satisfactory results as a whole. However, they have a major drawback associated firstly with their cost, which is very high, but, secondly, for polyethylene, they have limited fatigue strength, poor crack propagation strength and poor conventional yield point elongation (about 10% at 23° C.). As regards modified or non-elastomeric polyamides, they have limited resistance to hydrolysis. The characteristics of these materials are considered as negative and penalizing with regard to the constraints mentioned hereinabove, and are especially so in “dynamic” applications, i.e. the rising pipes (“risers”) that connect a subsea installation to surface equipment. Moreover, another constraint may be exerted on these outer sheaths as a result of the diffusion of gases into the annular space for the transportation of certain fluids. Such diffusion is well known and drainage systems are provided to allow control of the pressure prevailing in the annular space. However, these gas discharge systems can only function for specified pressure gradients between the pressure in the annular space and the external pressure, which obliges the outer sheath to withstand this difference.

Materials that are substantially less expensive such as certain elastomeric thermoplastics are known in other fields, which are used, for instance, to form seals or various components and which are well known especially in the motor vehicle industry. These elastomeric thermoplastics are, for example, TPU, SBS/SEBS, copolyetheresters, copolyetheramides, EPDM/PP, TPO or TPOVD.

These elastomeric thermoplastics are generally sought for their ability to be used in methods similar to those used for thermoplastics (extrusion, injection-molding, molding) combined with their elasticity properties or their deformability, which are imparted to them by the elastomer they contain. However, these elastomeric thermoplastics have characteristics that tend to prevent their use in the field of offshore petroleum pipes and more particularly for “dynamic” structures. Thus, they generally show poor resistance to UV exposure and present aging problems under the external environment conditions encountered in the specific offshore application. In their common commercial forms, may also have an excessively high deformability due to their formulation with a generally large amount of extenders. These extender-rich formulations are unusable in the context of an outer coating for a pipeline especially on account of their high strain combined with large local pressures and axial constraints generated by the tensioners and/or the hanging weight of the flexible pipe during the laying operations.

It is for all these reasons that those skilled in the art have been led to switch from this category of material to thermoplastic materials whose characteristics satisfy the requirements demanded for marine petroleum development. However, it has been discovered, surprisingly, by the Applicant, contrary to all these preconceptions, that certain elastomeric thermoplastics can be used under certain conditions to form polymer sheaths for flexible pipes for offshore petroleum applications and more particularly in the context of “dynamic” flexible structures.

The aim of the invention is thus to propose a flexible fluid transportation pipe of the type used in offshore petroleum development, at least the outer sheath or the intermediate sheath of which is made of elastomeric thermoplastic, despite the prohibitive obstacles previously reported and the preconceptions of those skilled in the art.

According to another characteristic of the invention, the elastomeric thermoplastic is advantageously made on the basis of a polyolefin such as polypropylene combined with an elastomer chosen from the following elastomers:
SBS (styrene butadiene styrene)
SEBS (styrene ethylene butadiene styrene)
EPDM (ethylene propylene diene monomer)
polybutadiene
polyisoprene
polyethylene-butylene

The elastomeric thermoplastic sheath obtained preferentially has a yield point stress σₛ of greater than 20 MPa at 23° C., a resistance to thermal oxidation OIT of greater than 40 minutes at 210° C. and a UV stability of greater than 1500 hours (Xenotest or Weather-O-meter or equivalent). Furthermore, the elastomer used is advantageously crosslinked.

### Other characteristics and advantages of the invention will emerge from the description that follows, with regard to the attached drawings, which are given merely as nonlimiting examples.

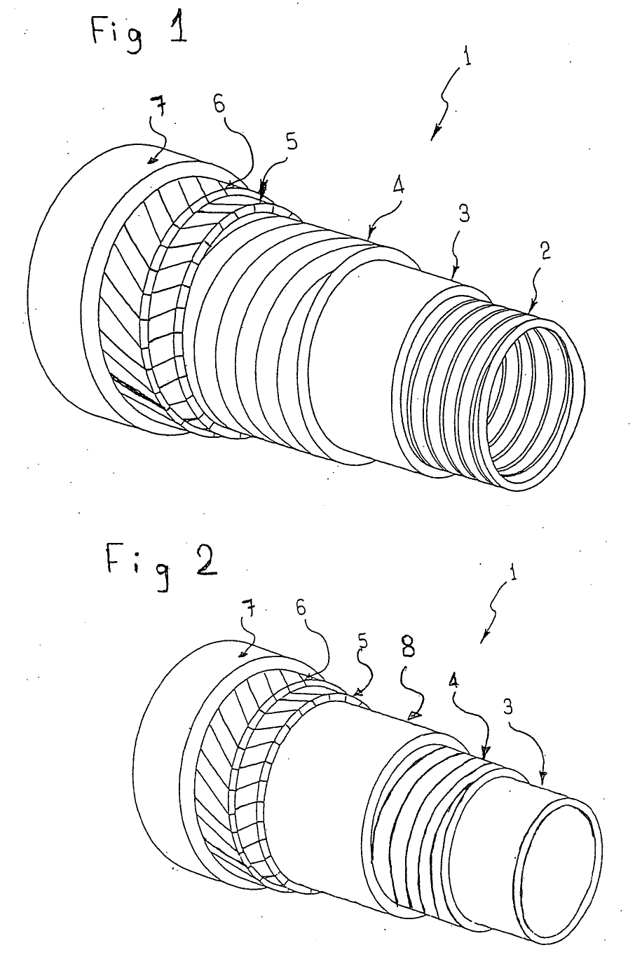

FIG. 1 diagrammatically represents in perspective a flexible pipe of the invention of “rough-bore” type and its various layers.

FIG. 2 diagrammatically represents in perspective a flexible type of “smooth-bore” type.

The flexible tubular pipe 1 of the invention is of the type for offshore petroleum development such as those defined by the recommendations of API 17B. It consists of an assembly of constituent layers comprising polymer sheaths and reinforcing or armoring layers, said layers possibly being, where appropriate, separated by coils of various bands for preventing creep of the sheaths or for forming thermal insulation, for example. It may furthermore be of the bonded, unbonded or semibonded type depending on whether the various layers are fully, partially or not at all bonded together by a plastic matrix. The flexible tubular pipe 1 of the invention is advantageously a pipe of the riser type connecting a subsea installation to a surface installation (buoy, platform, FPSO, etc.).

According to the embodiment illustrated in FIG. 1, the flexible pipe bearing the general reference 1 is of the unbonded type and of “rough-bore” type, the innermost element being formed by a metallic carcass. The carcass 2 is formed from a short-pitch coil of a folded-seam strip and serves to support the impervious sheath 3 to prevent its potential collapse. An impervious sheath 3, also known as an inner sheath or pressure sheath, is located above the carcass 2. It is generally obtained by extrusion and serves to ensure the leaktightness of the “bore” in which the fluid circulates and to withstand the radial component of the internal pressure exerted by said fluid with the aid of the pressure armoring 4 covering it.

The pipe illustrated in FIG. 1 also comprises pressure armoring or a pressure vault 4 formed from a short-pitch coil of a folded-seam metallic reinforcing wire intended to take up the internal pressure with the pressure sheath covering it, and also laps of long-pitch coiled “tensile” armoring 5, 6 intended to take up the longitudinal forces to which the pipe may be subjected (longitudinal component of the laying pressure or laying forces, for example). It goes without saying that the pressure vault may also comprise a binding band. Similarly, it would not constitute a departure from the field of application of the present invention to produce pipes comprising laps of coiled tensile armoring with an angle close to 55° directly above the pressure sheath, and which would serve to take up both the radial and axial components of the internal pressure.

The flexible pipe 1 also comprises an outer protective sheath 7 for protecting the reinforcing layers 4, 5, 6 located in the annular space that it forms with the inner sheath.

According to one embodiment variant of the pipe 1 illustrated in FIG. 2, it comprises an intermediate sheath 8 in the form of an anti-collapse sheath located between the pressure vault 4 and the tensile armorings 5, 6. This sheath is especially intended for reducing the risks of collapse of the impervious sheath 3 when the outer sheath is damaged and when the annular space is subjected to the hydrostatic pressure, for example. It is thus intended to support this pressure with the aid of the vault on which it bears, preventing the hydrostatic pressure from being applied directly onto said impervious sheath.

According to the invention, the outer sheath 7 and/or the intermediate sheath 8 of the flexible pipe is made of elastomeric thermoplastic polymer (TPE). The thermoplastic block used to form the elastomeric thermoplastic polymer is chosen from the polyolefin family and is advantageously a polypropylene (PP); this polypropylene may be of the homopolymer family (PPH) or of the copolymer family (PPC). The elastomer used to combine with the thermoplastic is chosen from the butyl, EPDM (ethylene propylene diene monomer), SEBS (styrene ethylene butadiene styrene), SBS (styrene butadiene styrene), polyisoprene, polyethylene-butylene and polybutadiene families. The mass proportion of each of the components in the starting blend is between 30% and 70%.

In one embodiment of the invention, the elastomer is advantageously crosslinked. However, it may be envisioned to produce elastomeric thermoplastic polymer sheaths the elastomer of which is not crosslinked.

According to one of the preferred embodiments of the invention, the thermoplastic block used to form the elastomeric thermoplastic polymer (TPE) is a grafted olefin that may be post-process crosslinked (after extrusion). This olefin may be grafted with silane, for example, to allow crosslinking by hydrolysis, as described in patent EP 0 487 691 from the Applicant. However, the crosslinking process described in the Applicant's patent is not exhaustive, and other crosslinking processes may be applied depending on the elastomeric thermoplastic polymer formulation used; for instance, peroxide crosslinking and ionizing crosslinking.

The sheath 7, 8 is advantageously made of an elastomeric thermoplastic polymer that as a yield point stress σₛ of greater than 10 MPa. This yield point stress will preferably be chosen greater than 20 MPa. This yield point stress depends mainly on the ratio between the thermoplastic block and the elastomer and also on the content of extender present in the elastomeric thermoplastic polymer formulation. These various ratios will thus the optimized to obtain the required minimum yield point stress.

The elastomeric thermoplastic polymer used also comprises additives carefully chosen so as to impart intrinsic physical characteristics to the sheath (7, 8) produced which make it compatible with its use in offshore petroleum applications and more particularly dynamic applications.

Commercial elastomeric thermoplastic polymers commonly comprise thermal and UV stabilizers chosen from the family of sulfites and phenols. The stabilizers, such as those used in the claimed elastomeric thermoplastic polymers, are known under the trade name Irganox and more particularly Irganox HP 136 from CIBA (registered trademarks), which may be combined with costabilizers such as Irganox 1010 or 1076 (registered trademarks). The nature and amount of these antioxidants are chosen such that the elastomeric thermoplastic polymer obtained has high resistance to thermal oxidation. The antioxidants will thus be chosen so as to obtain an OIT at 210° C. of greater than 20 minutes and preferably greater than 40 minutes.

Furthermore, the elastomeric thermoplastic polymer will also comprise additives intended to reinforce the UV stability of the sheath 7, 8. These anti-UV additives will advantageously be chosen so as to give the material a stability of greater than 1500 hours (Xenotest or Weather-O-meter. Renault 1380 procedure or equivalent). UV stabilizers from the HALS family (hindered amine light stabilizers) will preferably be chosen since these stabilizers derive their efficacy from the fact that they do not absorb UV and are not consumed during the stabilization process, but are regenerated. These stabilizers are known commercially under the name Chimassorb (registered trademark) and may be combined with UV absorbers known under the name Tinuvin from the company CIBA (registered trademark). An example that may be mentioned is Tinuvin 783, consisting of Chimassorb 2944 and Tinuvin 522.

According to another characteristic of the thermoplastic material used, it comprises extenders for facilitating the use of the material. However, in order to avoid the drawbacks caused by the stresses during laying, the extender content will be chosen so as to allow a yield point stress of greater than 10 MPa to be obtained.

1. A flexible tubular pipe for transporting fluid in the field of offshore petroleum development, the pipe comprising from inside the pipe outward at least one impervious inner polymer sheath, one or more than one successively applied reinforcing layers each formed from coils of a reinforcing wires or of metallic strips or of long composite elements, at least one second polymer sheath defining at least one of an outer protective sheath or an intermediate sheath, wherein the second polymer sheath is comprised of elastomeric thermoplastic polymer (TPE).

2. The flexible tubular pipe as claimed in claim 1, wherein the thermoplastic of the elastomeric thermoplastic polymer (TPE) is an olefin.

3. The flexible tubular pipe as claimed in claim 2, wherein the thermoplastic of the elastomeric thermoplastic polymer (TPE) is a crosslinkable grafted olefin.

4. The flexible tubular pipe as claimed in claim 1, wherein the thermoplastic block used for the elastomeric thermoplastic polymer (TPE) is a polypropylene.

5. The flexible tubular pipe as claimed in claim 1, wherein elastomer is used to form the elastomeric thermoplastic polymer (TPE) and the elastomer is from the group of elastomers consisting of:
SBS (styrene butadiene styrene)
SEBS (styrene ethylene butadiene styrene)
EPDM (ethylene propylene diene monomer)
polybutadiene
polyisoprene
polyethylene-butylene

6. Flexible tubular pipe as claimed in claim 1, wherein the elastomeric thermoplastic polymer which forms the second polymer sheath has a yield point stress σₛ of greater than 10 MPa.

7. The flexible tubular pipe as claimed in claim 1, wherein the elastomeric thermoplastic which forms the second polymer sheath has a resistance to thermal oxidation OIT at 210° C. of greater than 20 minutes.

8. The flexible tubular pipe as claimed in claim 1, wherein the elastomeric thermoplastic which forms the second polymer sheath comprises anti-UV additives chosen such that its stability of the second sheath is greater than 1500 hours (Xenotest).

9. The flexible tubular pipe as claimed in claim 1, wherein the second sheath of elastomeric thermoplastic polymer defines the outer protective sheath of the pipe.

10. The flexible tubular pipe as claimed in claim 1, wherein the second sheath of elastomeric thermoplastic polymer defines an intermediate sheath of the pipe.
